(19) United States
(12) Patent Application Publication
(10) Pub. No.: US 2002/0178440 A1
(43) Pub. Date: Nov. 28, 2002

(54) Method and apparatus for automatically selecting an alternate item based on user behavior

(75) Inventors: Lalitha Agnihotri, Fishkill, NY (US); Mi-Suen Lee, Ossining, NY (US); Srinivas Gutta, Buchanan, NY (US)

Correspondence Address: Corporate Patent Counsel, U.S. Philips Corporation, 580 White Plains Road, Tarrytown, NY, 10591, US

(73) Assignee: Philips Electronics North America Corp.

(21) Appl. No.: 09/819,441

(22) Filed: Mar. 28, 2001

(51) Int. Cl. H04N 7/16; H04H 9/00; G06F 3/00; H04N 5/445; G06F 13/00

(52) U.S. Cl. 725/10; 725/12; 725/46

(57) ABSTRACT

A method and apparatus are disclosed for automatically selecting an alternate item based on user behavior. The disclosed television programming recommender monitors user behavior and automatically selects an alternate program when the viewer does not sufficiently like the current program selection. Detected predefined negative behavior includes, for example, (i) auditory commands, (ii) gestural commands, (iii) facial expressions, or (iv) other predefined behavior suggesting that the viewer dislikes the program. A flexible mechanism is provided for providing an alternate program selection.

### FIELD OF THE INVENTION

The present invention relates to recommendation systems, such as recommenders for television programming or other content, and more particularly, to a method and apparatus for automatically selecting an alternate recommended program or item.

### BACKGROUND OF THE INVENTION

The number of media options available to individuals is increasing at an exponential pace. As the number of channels available to television viewers has increased, for example, along with the diversity of the programming content available on such channels, it has become increasingly challenging for television viewers to identify television programs of interest. Historically, television viewers identified television programs of interest by analyzing printed television program guides. Typically, such printed television program guides contained grids listing the available television programs by time and date, channel and title. As the number of television programs has increased, it has become increasingly difficult to effectively identify desirable television programs using such printed guides.

More recently, television program guides have become available in an electronic format, often referred to as electronic program guides (EPGs). Like printed television program guides, EPGs contain grids listing the available television programs by time and date, channel and title. Some EPGs, however, allow television viewers to sort or search the available television programs in accordance with personalized preferences. In addition, EPGs allow for on-screen presentation of the available television programs.

Many viewers have a particular preference towards, or bias against, certain categories of programming, such as action-based programs or sports programming. A number of tools are available that recommend television programming by applying such viewer preferences to the EPG to obtain a set of recommended programs. While such television program recommenders identify programs that are likely of interest to a given viewer, they are not foolproof, and often recommend programs that are not of sufficient interest to the viewer. Thus, the viewer must affirmatively interact with the television, set-top terminal or remote control to select an alternate program.

A need therefore exists for a method and apparatus for automatically selecting an alternate program selection when a viewer does not sufficiently like a current program selection. A further need exists for a method and apparatus for evaluating the reaction of a viewer to presented content in real-time and for selecting an alternate program when the viewer dislikes the currently selected content. Yet another need exists for a method and apparatus for automatically selecting an alternate program without requiring a manual entry using a specific device.

### SUMMARY OF THE INVENTION

Generally, a method and apparatus are disclosed for automatically selecting an alternate item based on user behavior. The illustrative television programming recommender monitors viewer behavior and automatically selects an alternate program when the viewer does not sufficiently like the current program selection.

One or more audio/visual capture devices are focused on the user to monitor user behavior and detect predefined negative behavior suggesting that the user does not like a currently selected program. The detected predefined negative behavior may include, for example, (i) auditory commands, (ii) gestural commands, (iii) facial expressions, or (iv) other predefined behavior suggesting that the user dislikes the program.

Once predefined negative behavior is identified, an alternate program is selected. The present invention provides a flexible mechanism for providing an alternate program selection, since the user is not required to use a remote control or set-top terminal as an input mechanism.

A more complete understanding of the present invention, as well as further features and advantages of the present invention, will be obtained by reference to the following detailed description and drawings.

### BRIEF DESCRIPTION OF THE DRAWINGS

FIG. 1 illustrates a television programming recommender in accordance with the present invention;

FIG. 2 illustrates a sample table from the program database of FIG. 1;

FIG. 3A illustrates a sample table from a Bayesian implementation of the viewer profile of FIG. 1;

FIG. 3B illustrates a sample table from a viewing history used by a decision tree (DT) recommender;

FIG. 3C illustrates a sample table from a viewer profile generated by a decision tree (DT) recommender from the viewing history of FIG. 3B; and

FIG. 4 is a flow chart describing an exemplary alternate program selection process embodying principles of the present invention.

### DETAILED DESCRIPTION

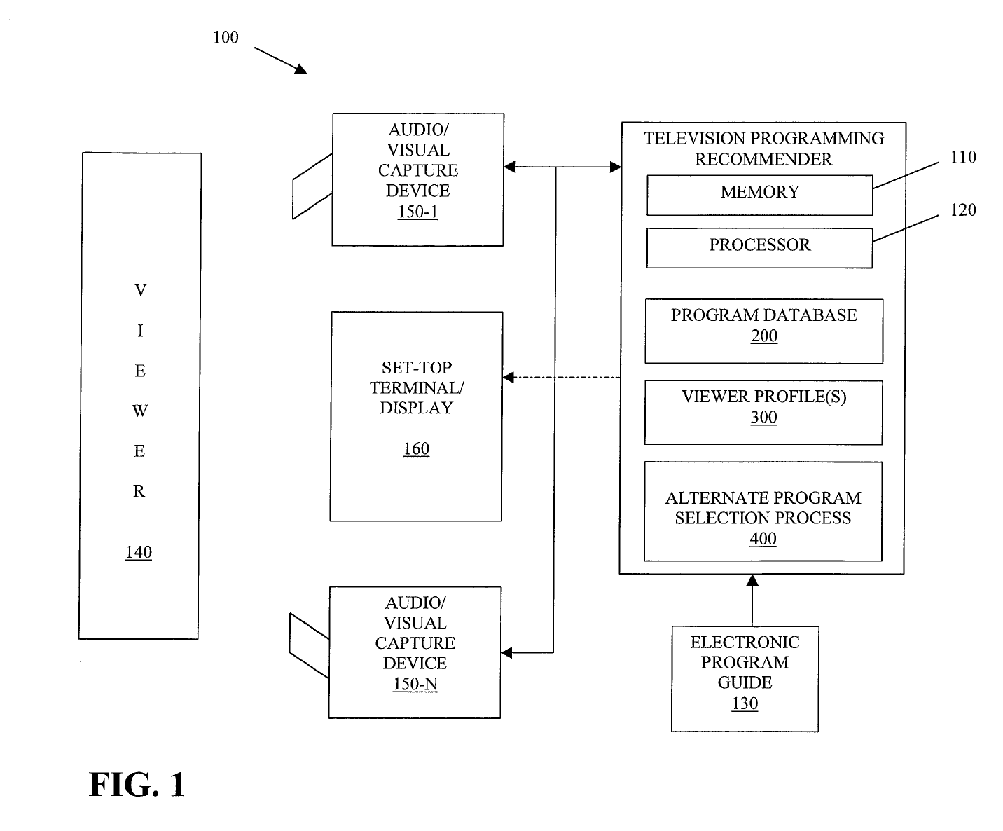

FIG. 1 illustrates a television programming recommender 100 in accordance with the present invention. As shown in FIG. 1, the television programming recommender 100 evaluates each of the programs in an electronic programming guide (EPG) 130 to identify programs of interest to one or more viewer(s) 140. The set of recommended programs can be presented to the viewer 140 using a set-top terminal/television 160, for example, using well known on-screen presentation techniques. While the present invention is illustrated herein in the context of television programming recommendations, the present invention can be applied to any automatically generated recommendations that are based on an evaluation of user behavior, such as a viewing history or a purchase history.

According to one feature of the present invention, the television programming recommender 100 monitors viewer behavior and automatically selects an alternate program when the viewer does not sufficiently like the current program selection. As shown in FIG. 1, the television programming recommender 100 includes one or more audio/visual capture devices 150-1 through 150-N (hereinafter, collectively referred to as audio/visual capture devices 150) that are focused on the viewer 140. The audio/visual capture devices 150 may include, for example, a pan-tilt-zoom (PTZ) camera for capturing video information or an array of microphones for capturing audio information, or both.

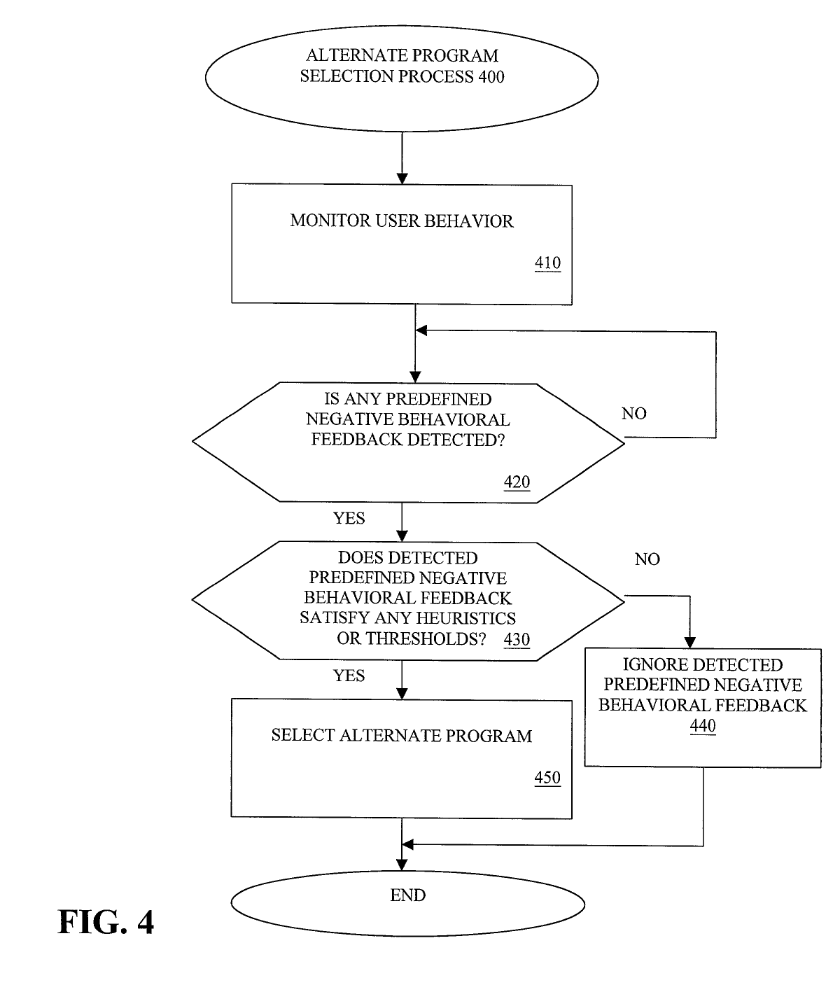

The audio or video images (or both) generated by the audio/visual capture devices 150 are processed by the television programming recommender 100, in a manner discussed below in conjunction with FIG. 4, to identify one or more predefined (i) auditory commands, (ii) gestural commands, such as a “thumbs down,” (iii) facial expressions, such as a sad or unhappy expression, (iv) other predefined behavior suggesting that the viewer dislikes the program, such as booing, walking away or not paying attention, or (v) a combination of the foregoing, hereinafter, collectively referred to as “predefined negative behavior.”

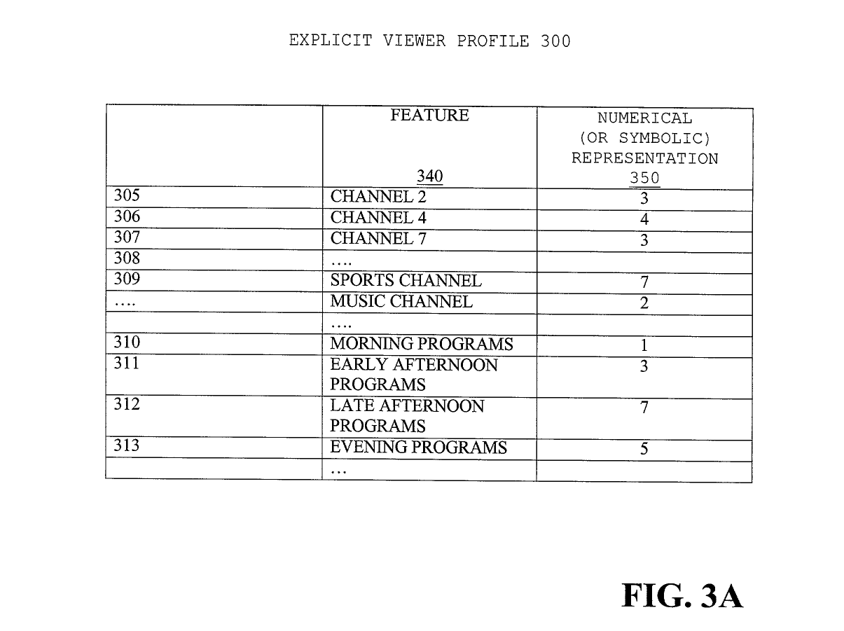

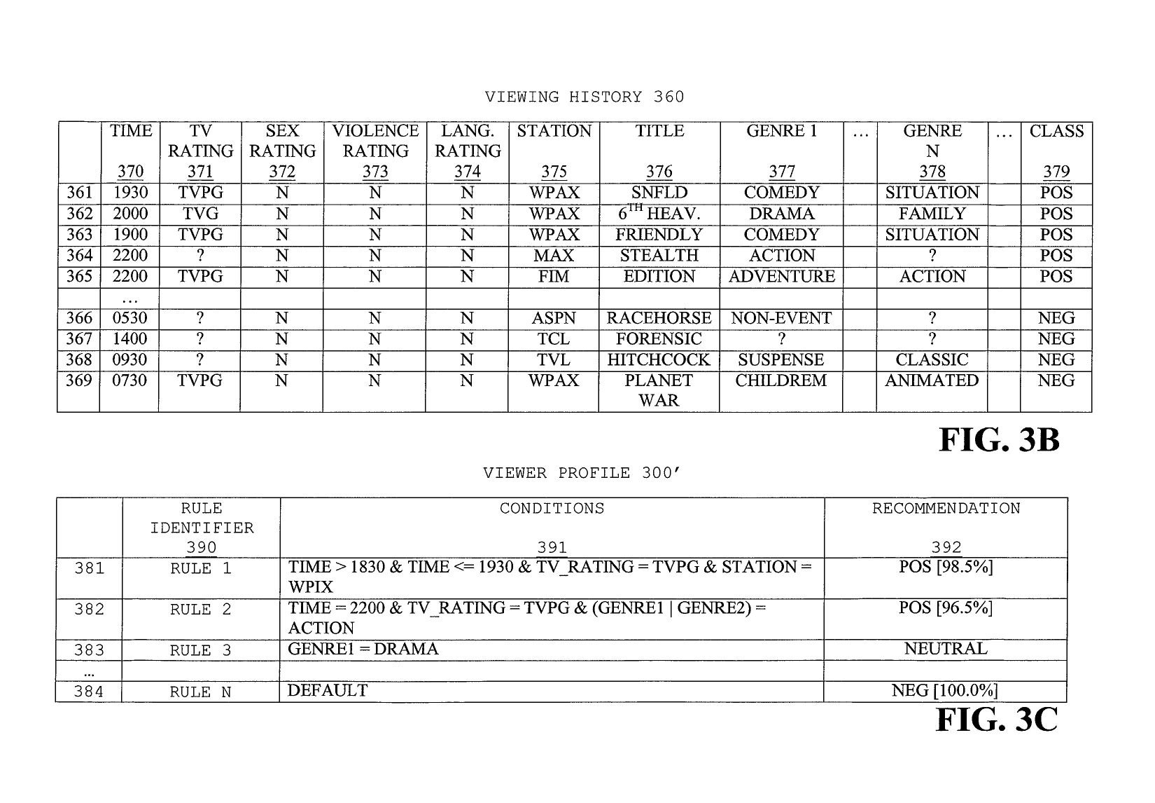

Once predefined negative behavior is identified, the television programming recommender 100 can select an alternate program and optionally update one or more viewer profiles 300, discussed below in conjunction with FIGS. 3A and 3C, in accordance with teachings of U.S. patent application Ser. No. 09/718,261, filed Nov. 22, 2000, entitled “Method and Apparatus for Obtaining Auditory and Gestural Feedback in a Recommendation System,” assigned to the assignee of the present invention and incorporated by reference herein. The viewer behavior can be (i) explicit, such as predefined auditory or gestural commands; or (ii) implicit, such as information that may be derived from user behavior (or both). In this manner, the present invention provides a flexible mechanism for providing an alternate program selection, since the user is not constrained to using a remote control or set-top terminal as an input mechanism.

In a further variation, the present invention can detect a change in the mood of a user and make an alternate program recommendation based on the new mood of the user. For a detailed discussion of a mood-based recommendation system, see U.S. patent application Ser. No. 09/718,260, filed Nov. 22, 2000, entitled “Method and Apparatus for Generating Recommendations Based on Current Mood of User,” assigned to the assignee of the present invention and incorporated by reference herein.

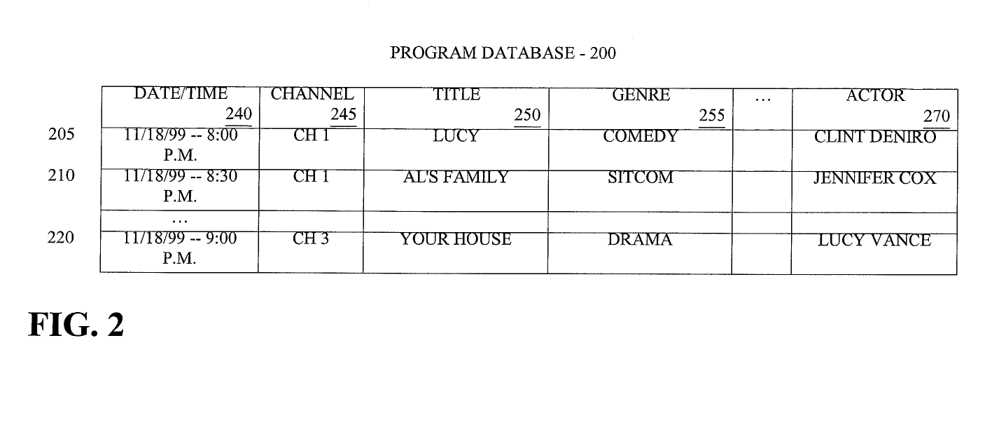

As shown in FIG. 1, the television programming recommender 100 contains a program database 200, one or more viewer profiles 300, and an auditory and gestural feedback analysis process 400, each discussed further below in conjunction with FIGS. 2 through 4, respectively. Generally, the program database 200 records information for each program that is available in a given time interval. One illustrative viewer profile 300, shown in FIG. 3A, is an explicit viewer profile that is typically generated from a viewer survey that provides a rating for each program feature, for example, on a numerical scale that is mapped to various levels of interest between “hates” and “loves,” indicating whether or not a given viewer watched each program feature. Another exemplary viewer profile 300′, shown in FIG. 3C, is generated by a decision tree recommender, based on an exemplary viewing history 360, shown in FIG. 3B. The present invention permits the survey response information, if any, recorded in the viewer profile 300 to be supplemented with the detected auditory or gestural feedback information.

The alternate program selection process 400 analyzes the audio or video images (or both) generated by the audio/visual capture devices 150 to identify predefined negative behavior. Once such predefined negative behavior is identified, the alternate program selection process 400 automatically selects an alternate program, such as the program with the next highest recommendation score.

The television program recommender 100 may be embodied as any computing device, such as a personal computer or workstation, that contains a processor 120, such as a central processing unit (CPU), and memory 110, such as RAM and/or ROM. The television program recommender 100 may also be embodied as an application specific integrated circuit (ASIC), for example, in a set-top terminal or display 160. In addition, the television programming recommender 100 may be embodied as any available television program recommender, such as the Tivo™ system, commercially available from Tivo, Inc., of Sunnyvale, Calif., or the television program recommenders described in U.S. patent application Ser. No. 09/466,406, filed Dec. 17, 1999, entitled “Method and Apparatus for Recommending Television Programming Using Decision Trees,” (Attorney Docket No. 700772), U.S. patent application Ser. No. 09/498,271, filed Feb. 4, 2000, entitled “Bayesian TV Show Recommender,” (Attorney Docket No. 700690) and U.S. patent application Ser. No. 09/627,139, filed Jul. 7, 2000, entitled “Three-Way Media Recommendation Method and System,” (Attorney Docket No. 700913), or any combination thereof, as modified herein to carry out the features and functions of the present invention.

FIG. 2 is a sample table from the program database 200 of FIG. 1 that records information for each program that is available in a given time interval. As shown in FIG. 2, the program database 200 contains a plurality of records, such as records 205 through 220, each associated with a given program. For each program, the program database 200 indicates the date/time and channel associated with the program in fields 240 and 245, respectively. In addition, the title, genre and actors for each program are identified in fields 250, 255 and 270, respectively. Additional well-known features (not shown), such as duration, and description of the program, can also be included in the program database 200.

FIG. 3A is a table illustrating an exemplary explicit viewer profile 300 that may be utilized by a Bayesian television recommender. As shown in FIG. 3A, the explicit viewer profile 300 contains a plurality of records 305-313 each associated with a different program feature. In addition, for each feature set forth in column 340, the viewer profile 300 provides a numerical representation in column 350, indicating the relative level of interest of the viewer in the corresponding feature. As discussed below, in the illustrative explicit viewer profile 300 set forth in FIG. 3A, a numerical scale between 1 (“hate”) and 7 (“love”) is utilized. For example, the explicit viewer profile 300 set forth in FIG. 3A has numerical representations indicating that the user particularly enjoys programming on the Sports channel, as well as late afternoon programming.

In an exemplary embodiment, the numerical representation in the explicit viewer profile 300 includes an intensity scale such as:

| Number | Description |
|---|---|
| 1 | Hates |
| 2 | Dislikes |
| 3 | Moderately negative |
| 4 | Neutral |
| 5 | Moderately positive |
| 6 | Likes |
| 7 | Loves |

FIG. 3B is a table illustrating an exemplary viewing history 360 that is maintained by a decision tree television recommender. As shown in FIG. 3B, the viewing history 360 contains a plurality of records 361-369 each associated with a different program. In addition, for each program, the viewing history 360 identifies various program features in fields 370-379. The values set forth in fields 370-379 may be typically obtained from the electronic program guide 130. It is noted that if the electronic program guide 130 does not specify a given feature for a given program, the value is specified in the viewing history 360 using a “?”.

FIG 3C is a table illustrating an exemplary viewer profile 300′ that may be generated by a decision tree television recommender from the viewing history 360 set forth in FIG. 3B. As shown in FIG 3C, the decision tree viewer profile 300′ contains a plurality of records 381-384 each associated with a different rule specifying viewer preferences. In addition, for each rule indentified in column 390, the viewer profile 300′ indentifies the conditions associated with the rule in field 391 and the corresponding recommendation in field 392.

For a more detailed discussion of the generating of viewer profiles in a decision tree recommendation system, see, for example, U.S. patent application Ser. No. 09/466,406, filed Dec. 17, 1999, entitled “Method and Apparatus for Recommending Television Programming Using Decision Trees, ” (Attorney Docket No. 700772), incorporated by reference above.

FIG. 4 is a flow chart describing an exemplary alternate program selection process 400. In the exemplary implementation of FIG. 4, the alternate program selection process 400 monitors the user behavior during step 410. A test is performed during step 420 to determine if any predefined negative behavior is detected. If it is determined during step 420 that predefined negative behavior is not detected, then program control returns to step 410 to continue monitoring.

If, however, it is determined during step 420 that predefined negative behavior is detected, then a further test is performed during step 430 to determine if the detected predefined negative behavior satisfies any additional specified heuristics or thresholds, such as a at least minimum amount of time remaining until the next program change. In other words, if there is only a relatively short amount of time remaining in the current selected program, then the predefined negative behavior will be ignored. Thus, if it is determined during step 430 that the detected predefined negative behavior fails to satisfy any additional specified heuristics or thresholds, then the predefined negative behavior is ignored during step 440.

If, however, it is determined during step 430 that the detected predefined negative behavior satisfies any additional specified heuristics or thresholds, then program control proceeds to step 450, where a new program is selected. For example, the alternate program selection process 400 can optionally select the program with the next highest recommendation score. As previously indicated, can detect a change in the mood of a user and make an alternate program recommendation based on the new mood of the user, as described in U.S. patent application Ser. No. 09/718,260, filed Nov. 22, 2000, entitled “Method and Apparatus for Generating Recommendations Based on Current Mood of User,” assigned to the assignee of the present invention and incorporated by reference herein. For example, if the user is tired, a less intensive program may be selected, such as an action-based program over a drama.

It is to be understood that the embodiments and variations shown and described herein are merely illustrative of the principles of this invention and that various modifications may be implemented by those skilled in the art without departing from the scope and spirit of the invention.

What is claimed is:

1. A method for selecting an item for a user, comprising the steps of:
providing a first item to said user;
analyzing at least one of audio and video information focused on said user to identify predefined negative behavior suggesting that said user does not like said first item; and
selecting an alternate item if said predefined negative behavior is detected.

2. The method of claim 1, wherein said first and alternate items are media content selections.

3. The method of claim 1, wherein said alternate item is selected based on viewing preferences of said user.

4. The method of claim 1, wherein said predefined negative behavior includes auditory commands.

5. The method of claim 1, wherein said predefined negative behavior includes gestural commands.

6. The method of claim 1, wherein said predefined negative behavior includes deriving user preferences from a facial expression of said user.

7. The method of claim 1, wherein said selecting step is performed by a program content recommender.

8. A method for selecting an item for a user, comprising the steps of:
providing a first item to said user;
monitoring said user using at least one of an audio and a video device focused on said user to determine whether said user likes said first item; and
selecting an alternate item if said user demonstrates behavior suggesting that said user does not like said first item.

9. The method of claim 8, further comprising the step of defining a plurality of predefined negative behavior suggesting that said user does not like said first item.

10. The method of claim 8, wherein said first and alternate items are media content selections.

11. The method of claim 8, wherein said alternate item is selected based on viewing preferences of said user.

12. The method of claim 8, wherein said predefined negative behavior includes auditory commands.

13. The method of claim 8, wherein said predefined negative behavior includes gestural commands.

14. The method of claim 8, wherein said predefined negative behavior includes deriving user preferences from a facial expression of said user.

15. The method of claim 8, wherein said selecting step is performed by a program content recommender.

16. A system for selecting an item for a user, comprising:
a memory for storing computer readable code and said user profile; and
a processor operatively coupled to said memory, said processor configured to:
provide a first item to said user;
analyze at least one of audio and video information focused on said user to identify predefined negative behavior suggesting that said user does not like said first item; and
select an alternate item if said predefined negative behavior is detected.

17. A system for selecting an item for a user, comprising:
an audio and a video device focused on a user;
a memory for storing computer readable code and said viewer profile; and
a processor operatively coupled to said memory, said processor configured to:
provide a first item to said user;
monitor said user using at least one of an audio and video device focused on said user to determine whether said user likes said first item; and
select an alternate item if said user demonstrates behavior suggesting that said user does not like said first item.

18. The system of claim 17, wherein said processor is further configured to define a plurality of predefined negative behavior suggesting that said user does not like said first item.

19. An article of manufacture for selecting an item for a user, comprising:
a computer readable medium having computer readable code means embodied thereon, said computer readable program code means comprising:
a step to provide a first item to said user;
a step to analyze at least one of audio and video information focused on said user to identify predefined negative behavior suggesting that said user does not like said first item; and
a step to select an alternate item if said predefined negative behavior is detected.

20. An article of manufacture for selecting an item for a user, comprising:
a computer readable medium having computer readable code means embodied thereon, said computer readable program code means comprising:
a step to provide a first item to said user;
a step to monitor said user using at least one of audio or video information generated by an audio or video device to determine whether said user likes said first item; and
a step to select an alternate item if said user demonstrates behavior suggesting that said user does not like said first item.
